(19) United States
(12) Patent Application Publication
(10) Pub. No.: US 2015/0106880 A1
(43) Pub. Date: Apr. 16, 2015

(54) Authorized Document Distribution and Transmission Control By Groups of Categorized Clauses Apparatus and Method

(71) Applicant: BARRACUDA NETWORKS, INC., Campbell, CA (US)

(72) Inventors: Thorfinn Clark, Beverly Hills, CA (US); Chris Hawkins, Costa Mesa, CA (US)

(73) Assignee: BARRACUDA NETWORKS, INC., CAMPBELL, CA (US)

(21) Appl. No.: 14/053,411

(22) Filed: Oct. 14, 2013

(51) Int. Cl. H04L 29/06

(52) U.S. Cl. CPC H04L 63/08
USPC 726/4

(57) ABSTRACT

A document is categorized according to clauses and groups of clauses. A distribution and transmission control system determines from a user login credential if the document may be stored to removable, transportable media or transmitted to an external server through network connections. A scoring system determines the level of sensitivity of the document according to its component clauses and resulting document category. Even if headers and footers are removed from a sensitive document, its component clauses flag the category and sensitivity.

### RELATED APPLICATIONS

Co-pending applications are Document Categorization By Rules and Clause Group Scores Associated with Type Profiles Apparatus and Method application Ser. No. ______ filed 2013 Oct. 14; Transformation of Documents To Display Clauses In Variance From Best Practices and Custom Rules Score Apparatus and Method application Ser. No. ______ filed 2013 Oct. 14; and Identification of Clauses in Conflict Across a Set of Documents Apparatus and Method application Ser. No. ______ filed 2013 Oct. 14.

### BACKGROUND OF THE INVENTION

A general problem that arises in large entities is that reviewing and analyzing certain document categories in anticipation of liability and compliance exposures is requisite for organizations but consumes a time and expense for their executives, their staff, their attorneys, their owners, or their representatives and may substantially delay revenue recognition.

As is known, existing workflow management systems do not provide an apparatus to categorize legal instruments by component clauses; analyze groups of clauses to surface potential risk and liability across all contracts agreed to by an enterprise; examine each category of document using rules that provide positive or negative scores.

Categories of document have normally present clauses and absences but variations may not be noticed or different operating groups may diverge in their use or consistency. Conglomerates which have combined former independent companies may not have a way to identify interaction between and among contractual obligations negotiated separately which in combination constrain the freedom of an enterprise to operate or which generate liability and compliance exposures. As a result the productivity of corporate legal counsel in reviewing documents, highlighting unusual or non-standard limitations, and consolidating best practices among acquired operating businesses is below optimal and costly or omitted. Within this application we use “clause” to specifically mean a group of words which are syntactically related, containing a subject and predicate, and forming part of a sentence or constituting a whole simple sentence.

Thus it can be appreciated that what is needed is a system which receives a document and categorizes it, subscribes to a best practices knowledge base, and grades and scopes the received document to display the variances from best practices to a operator in a workflow appropriate to the category of document.

### SUMMARY OF THE INVENTION

A distribution and transmission control system determines from a user login credential if the document may be stored to removable, transportable media or transmitted to an external server through network connections. An apparatus transforms legal agreements and documents to identify groups of clauses or sections, which violate rules or best practices for their respective categories. A method controls a processor to score categorized legal agreements and documents according to clusters of clauses and the presence or absence of clause groups typical for each category. For each category, rules are applied to measure consistency with best practices, industry standards, and a company's legacy policies. Work items are flagged if they are out-of-norm, create liability or compliance exposure, or contain mutually conflicting commitments. Rules are applied to ensure that corporate governance exceptions are remediated. Within a workflow, documents are transformed with annotation to highlight sections, which may require escalations to an executive appropriate to the degree of risk exposure. Security is maintained over control of document access. We define clauses within this patent application as a group of words, which are syntactically related, containing a subject and predicate and forming part of a sentence or constituting a whole simple sentence.

A system categorizes a document according to clauses and groups of clauses. A distribution and transmission control system determines from a user login credential if the document may be stored to removable, transportable media or transmitted to an external server through network connections. A scoring system determines the level of sensitivity of the document according to its component clauses and resulting document category. Even if headers and footers are removed from a sensitive document, its component clauses flag the category and sensitivity.

To build a system, legacy documents of an enterprise are scanned and analyzed to determine best practices and rules for each category. Clauses and groups of clauses are assigned scores for relative value. Each category of documents has a profile of the clauses and groups of clauses, which establish a norm against which proposed new documents may be scored. A document is analyzed for clauses and groups of clauses. A score is determined for each document to measure its fit with a document category. An absence of an expected clause within group of clauses results in a lower score. An absence of a group of expected clauses results in an even lower score. A high score reflects that a document is substantially standard with its category.

Once a system is in operation, new (candidate) documents are scored and displayed with annotations for best practices, and variances from normal ranges of clauses and clause groups. Custom rules developed for an industry or for an enterprise further distinguish which documents need further review or approval by senior staff because of higher risks or commitments than standard terms and conditions. A display provides the document transformed with annotations about the scores or rules triggered by each group of clauses and accepts comments and approval or objections to acceptance of the document. The absence of best practices clauses for the category is noted.

Heritage documents are analyzed for best practices and compliance with rules normalized for an industry or an enterprise by identifying, grouping, and scoring clauses. Key clauses in each stored document are identified which distinguish a relationship with restrictions on the principal party. A document set containing potentially conflicting restrictions is scanned for any clauses, which mutually conflict. Documents with circular dependencies, obligations on the same resources, commitments to exclusivity, or compel action or inaction are surfaced for renegotiation, risk remediation, or conflict resolution.

A set of categorized legal agreements and documents may be scored according to clusters of clauses. For each category rules are applied to measure consistency with best practices, industry standards, and a company's legacy policies. Work items are flagged if they are out-of-norm, create liability or compliance exposure, or contain mutually conflicting commitments. Rules are applied to ensure that corporate governance exceptions are remediated, workflow escalations are appropriate to the authority of the actors, and security is maintained over control of document access.

The method of operation includes controlling a processor to cause: reading a plurality of documents to extract clauses; examining profiles of clauses for characteristics of a category; surfacing clauses which incur risks or liability; assigning positive or negative weights to clauses by rules; scoring documents according to components; annotating documents by missing parts and scores; determining non-normal components; transforming a document to display risks and variances from normal.

An apparatus contains some or all of the following component circuits: A knowledge base of best practices approved or desired for agreements; a parsing engine to determine key elements (key words, sections, subtitles, paragraphs); a document categorization filter to direct a submitted document to a scoring engine; a clause identifier to determine sections which require certain evaluations; a scoring engine to quantify how close each section is to a desired or preferred goal; and/or an information engine to integrate, display and receive results of analysis and commentary.

### BRIEF DESCRIPTION OF DRAWINGS

The present invention will be understood more fully from the detailed description given below and from the accompanying drawings of various embodiments of the invention, which, however, should not be taken to limit the invention to the specific embodiments, but are for explanation and understanding only.

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 is a block diagram of an exemplary computer system.

FIGS. 2, 3, 5, 7, 9, 10, 12 and 20 are block diagrams.

FIGS. 4, 6, 8, 11, and 13-19 are flowcharts of methods.

### DETAILED DISCLOSURE OF EMBODIMENTS

The invention provides transformation of one or more documents into a report or display with the following beneficial values:

a. Security. Rules may be applied at the edge of the network or at points of removable media to refuse the transmission of documents with certain groups of clauses without authorization. Transferring categories of documents may be refused without multiple approvals.

b. Risk Remediation. A regulatory body may specify a report that certain actions were taken (insurance, renegotiation, cancellation) to address compliance, risk, or liability exposure which is traced to one or more legal agreements which have already been executed. Detection of conflicting clauses across a document set, each of which is internally consistent: e.g. grants of exclusive rights, territories, licensure, or occupancy.

c. Authority to Operate. A line executive has authority to execute standard agreements or agreements within a range of variances. A workflow may certify that the documents are within his or her scope and trace the transfer of out of variance documents for further legal or executive approval. A line executive may provide evidence that his decisions were within scope by having reports of the categorization results.

d. Professional Productivity. Subject experts who receive documents to review, comment, and verify may productively receive a display which transforms the documents by highlighting or scoring portions which violate or alternately, which comply with rules, utilize or diverge from by (best practices), or record the professional's work product as comments, questions, or finding of legal equivalence. Records of previously approved document portions (when, by whom) can be annotated to component sections.

Reference will now be made to the drawings to describe various aspects of exemplary embodiments of the invention. It should be understood that the drawings are diagrammatic and schematic representations of such exemplary embodiments and, accordingly, are not limiting of the scope of the present invention, nor are the drawings necessarily drawn to scale.

In the following description, numerous details are set forth. It wall be apparent, however, to one skilled in the art, that the present invention may be practiced without these specific details. In other instances, well-known structures and devices are shown in block diagram form, rather than in detail, in order to avoid obscuring the present invention.

Some portions of the detailed descriptions which follow are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the descriptions, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer systems registers and memories into other data similarly represented as physical quantities within the computer system memories or registers or other such non-transitory information storage, communication circuits for transmitting or receiving, or display devices.

The present invention also relates to apparatus for performing the operations herein. This apparatus may be specifically constructed for the required purposes, or it may comprise application specific integrated circuits which are mask programmable or field programmable, or it may comprise a general purpose processor device selectively activated or reconfigured by a computer program comprising executable instructions and data stored in the computer. Such a computer program may be stored in a non-transitory computer readable storage medium, such as, but not limited to, any type of disk including floppy disks, optical disks, CD-ROMs, magnetic-optical disks, solid state disks, flash memory, read-only memories (ROMs), random access memories (RAMs), EPROMS, EEPROMS, magnetic or optical cards, or any type of non-transitory media suitable for storing electronic instructions, and each coupled to a computer system data communication network.

The algorithms and displays presented herein are not inherently related to any particular computer, circuit, or other apparatus. Various configurable circuits and general purpose systems may be used with programs in accordance with the teachings herein, or it may prove convenient to construct more specialized apparatus to perform the required method steps in one or many processors. The required structure for a variety of these systems will be appear from the description below. In addition, the present invention is not described with reference to any particular programming language or operating system environment. It will be appreciated that a variety of programming languages, operating systems, circuits, and virtual machines may be used to implement the teachings of the invention as described herein.

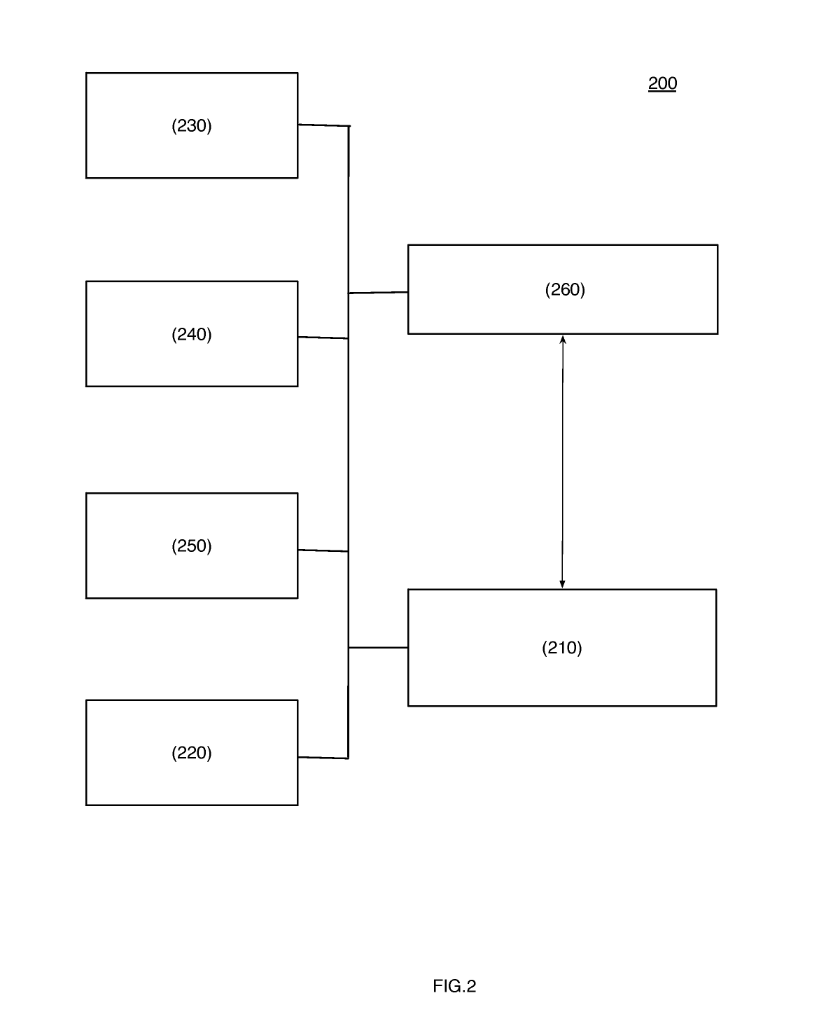

Referring now to FIG. 2, the present invention is a transformation apparatus 200 for grading compliance of documents to category best practices which has a knowledge base 210 of best practices approved or desired for agreements; coupled to, a parsing engine 220 to determine key elements (key words, sections, subtitles, paragraphs; a document categorization filter 230 to direct a submitted document to a scoring engine 240; a clause identifier circuit 250 to determine sections which require certain evaluations; the scoring engine 240 to quantify how close each section is to a desired or preferred goal; and an information engine 260 to integrate, receive, store, and display results of analysis and commentary.

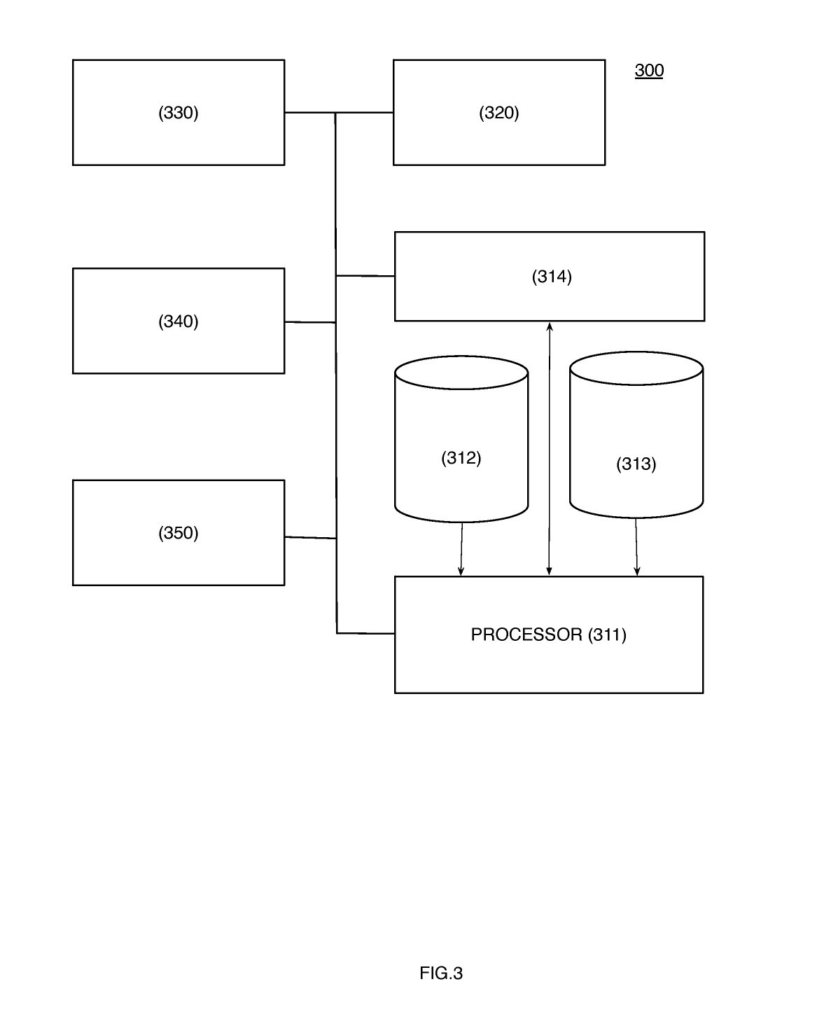

One aspect of the invention is a network device 300 of FIG. 3 having a processor 311 coupled to a document store 312, a directory 313 of users and resources, and a network interface 314; a circuit 320 to determine groups of clauses embedded in a selected document; a circuit 330 to identify an authority of a user to access a distribution medium related to a category of clause groups; a circuit 340 to enable or deny a request from an authorized user to access a distribution medium for a document having a group of clauses; and a circuit 350 to record the success or failure of an authorized user to access a distribution medium for a document having a category of clause groups.

In an embodiment, a distribution medium is a removable personal store or an email, or a website, or an upload to an IP server. In an embodiment, a distribution medium is a data communication logical device.

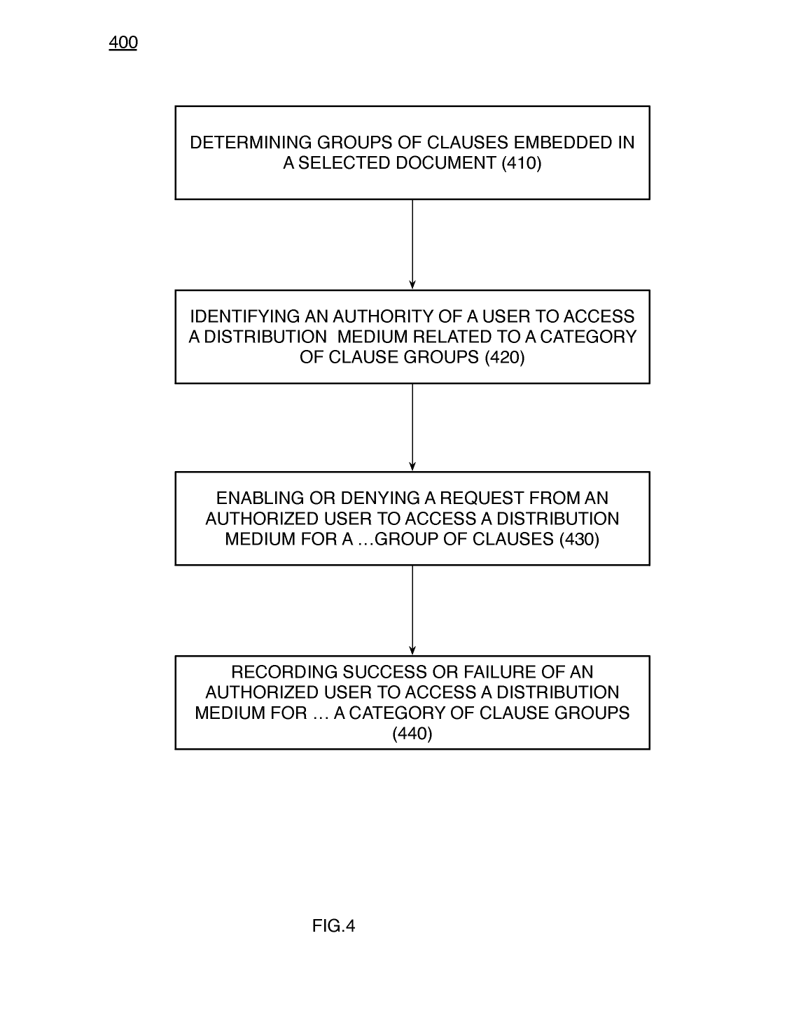

An other aspect of the invention is a method 400 of FIG. 4 for operation of a apparatus: determining groups of clauses embedded in a selected document 410; identifying an authority of a user to access a distribution medium related to a category of clause groups 420; enabling or denying a request from an authorized user to access a distribution medium for a document having a group of clauses 430; and recording the success or failure of an authorized user to access a distribution medium for a document having a category of clause groups 440.

In an embodiment, accessing a distribution medium is writing a removable personal store or transmitting an email, or connecting to a website, or an uploading to an IP server. In an embodiment, accessing a distribution medium is attaching a data communication logical device.

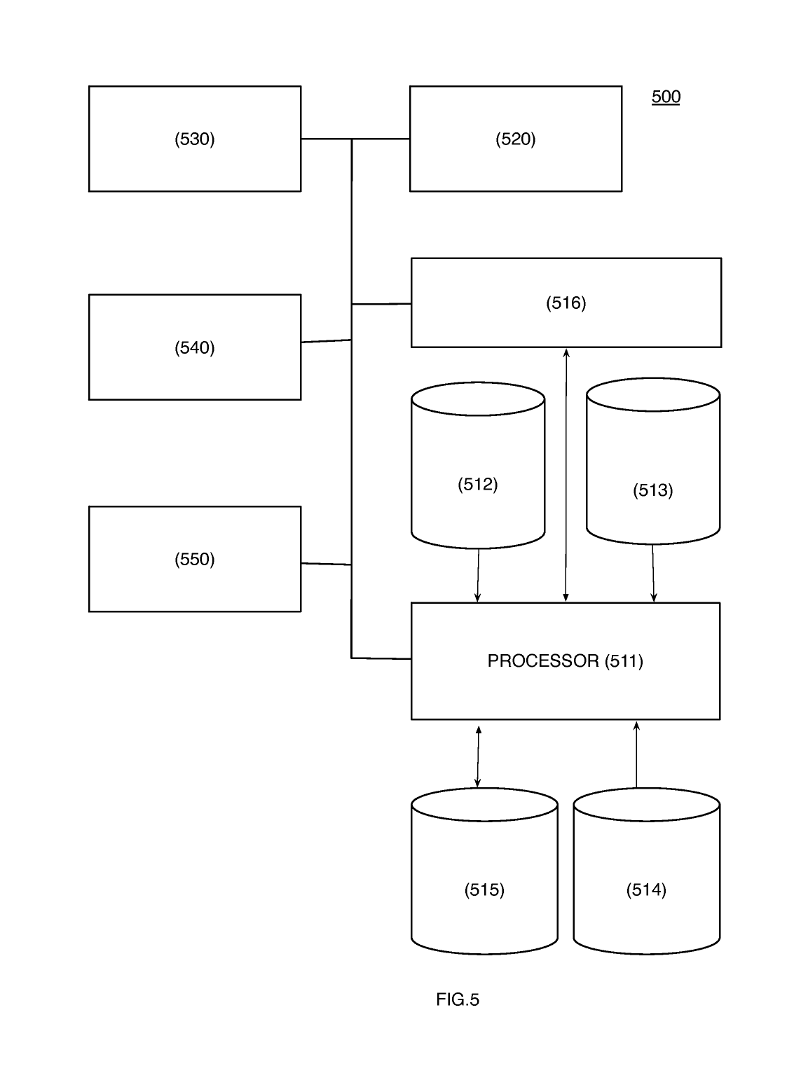

Another aspect of the invention is an apparatus 500 of FIG. 5 to determine clauses and groups of clauses in a document which are substantially consistent with best practices for a category of documents, the apparatus comprising: a processor 511 coupled to a document store 512, a computer-readable data and instruction store 513, a best practices store 514, a rules store 515, and a network interface 516; a circuit 520 to identify clauses and group related clauses within a document; a circuit 530 to apply rules for a plurality of document categories to the document; a circuit 540 to determine a score for a document in each of a plurality of document categories; and a circuit 550 to assign a document to at least one document category according to the score determined for it.

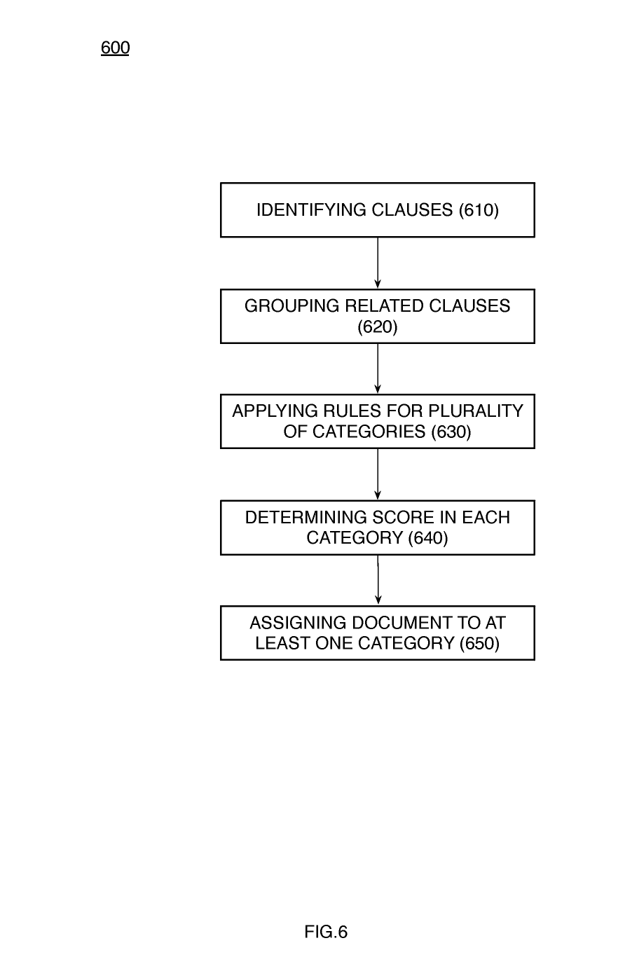

Another aspect of the invention is a method 600 of FIG. 6 to cause an apparatus to determine clauses and groups of clauses in a document which are substantially consistent with best practices for a category of documents, by identifying 610 clauses and grouping 620 related clauses within a document; applying 630 rules for a plurality of document categories to the document; determining 640 a score for a document in each of a plurality of document categories; and assigning 650 a document to at least one document category according to the score determined for it.

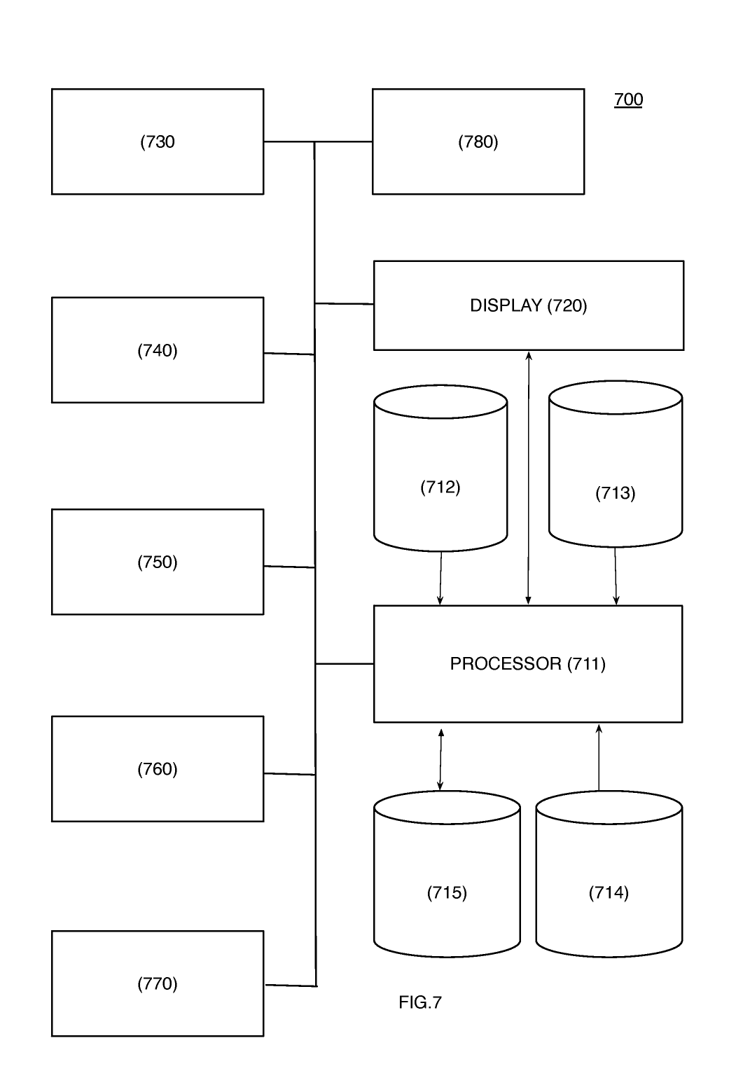

Another aspect of the invention is an apparatus 700 of FIG. 7 to display which clauses of a document should be reviewed and approved for apparent inconsistency with the best practices and custom rules of their enterprise and industry which includes a processor 711 coupled to a display 720, a computer-readable store for data and instructions 712, a document store 713, a rules store 714, and a document store 715; a circuit 730 to identify clauses and group related clauses; a circuit 740 to assign the document to a category according to its similarity with clauses and groups of clauses typical for the category; a circuit 750 to score clauses and groups of clauses for relative adoption of best practices for its category of documents; a circuit 760 to read and apply custom rules for the industry or enterprise to the document; a circuit 770 to transform the document with visual annotation and text according to the rules, and scores; and a circuit 780 to receive and record user commentary, remarks, approval, or objections to the transformed document.

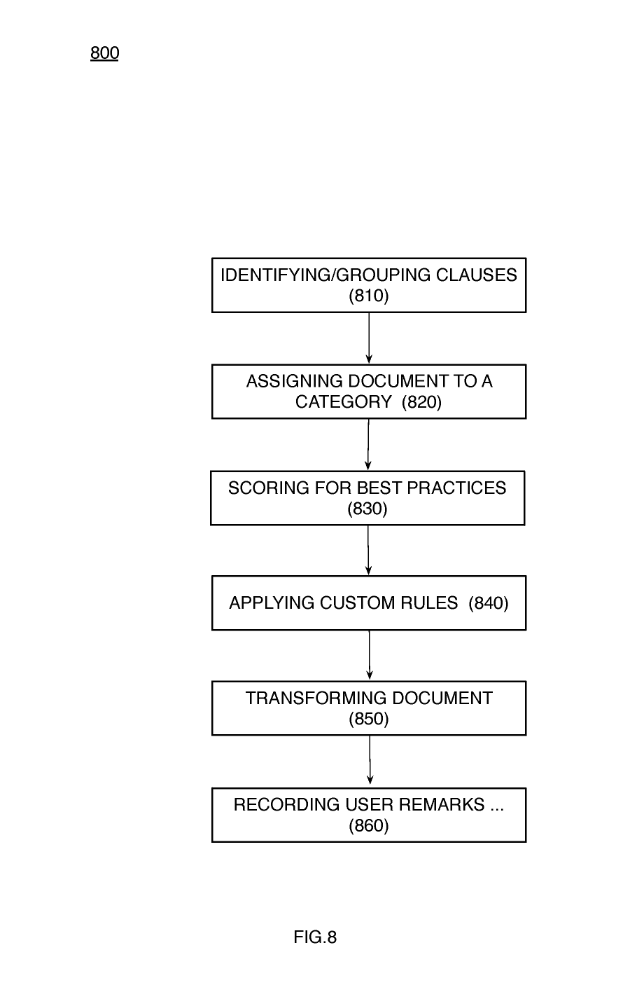

Another aspect of the invention is a method 800 of FIG. 8 for operating a processor by identifying 810 clauses and group related clauses; assigning 820 the document to a category according to its similarity with clauses and groups of clauses typical for the category; scoring 830 clauses and groups of clauses for relative adoption of best practices for its category of documents; reading and applying custom rules for the industry or enterprise to the document 840; transforming 850 the document with visual annotation and text according to the rules, and scores; and receiving and recording user commentary, remarks, approval, or objections to the transformed document 860.

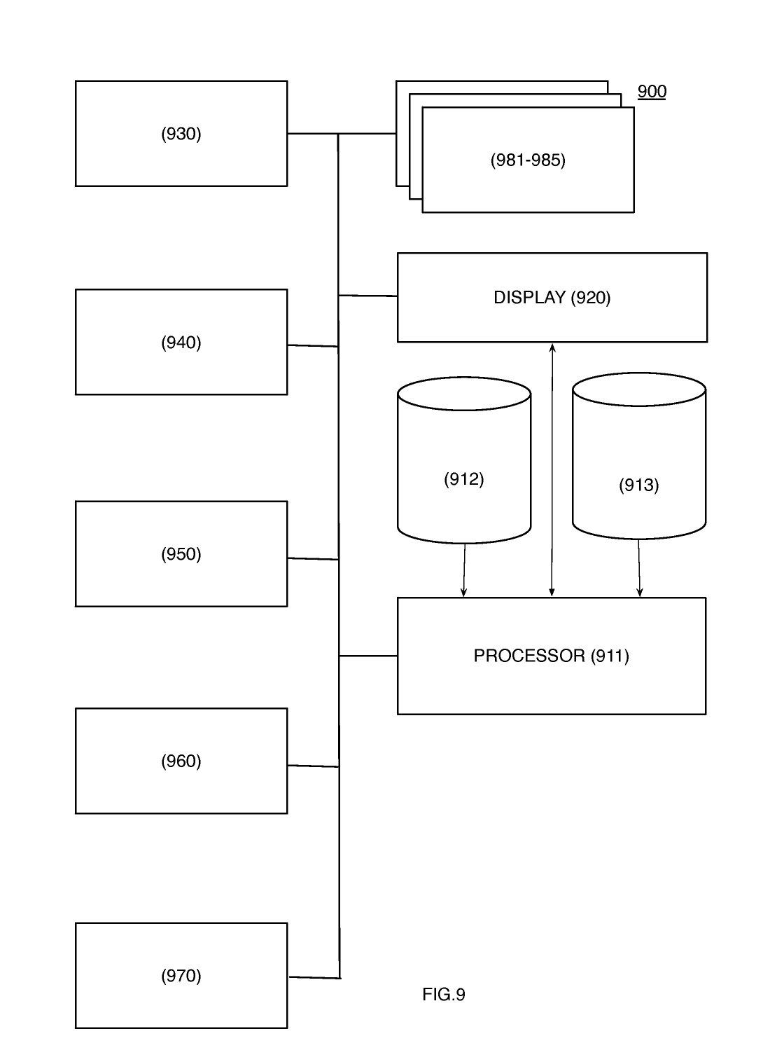

An aspect of the invention is an apparatus 900 of FIG. 9 for determining identification of clauses in conflict across a set of documents having a processor 911, a computer-readable store 912, and a display 920, mutually coupled to a document store 913 of documents determined to be in a category; a circuit 930 for receiving and storing a plurality of documents; a circuit 940 for scoring and categorizing each of a plurality of documents. In an embodiment, the apparatus has a circuit 950 for selecting documents in category with substantially similar scores; and a circuit 960 identifying documents containing clause groups with potential exclusivity rights.

In an embodiment, the apparatus has a circuit 970 for identifying documents containing clause groups with tangible property rights; a circuit 981 for identifying documents containing clause groups which compel action or inaction; a circuit 983 for identifying documents which have a dependency on another document; and a circuit 985 for identifying documents which fully obligate a unique resource.

In an embodiment, an exclusive right is for a territory or country, or region, or coordinate range. In an embodiment, an exclusive right is a product or service. In an embodiment, an exclusive right is occupancy of a property. In an embodiment, an exclusive right is licensing of intellectual property. In an embodiment, total obligations spanning one or more agreements exceed 100% of a whole or a fixed maximum is detected. In an embodiment, an action which is both forbidden and mandatory is detected. In an embodiment, a circular dependency among documents which cannot be resolved is detected.

In an embodiment, the apparatus determines that a resource which cannot be duplicated is fully obligated to more than one consumer. In an embodiment, an exclusive right is in a time period or is open ended.

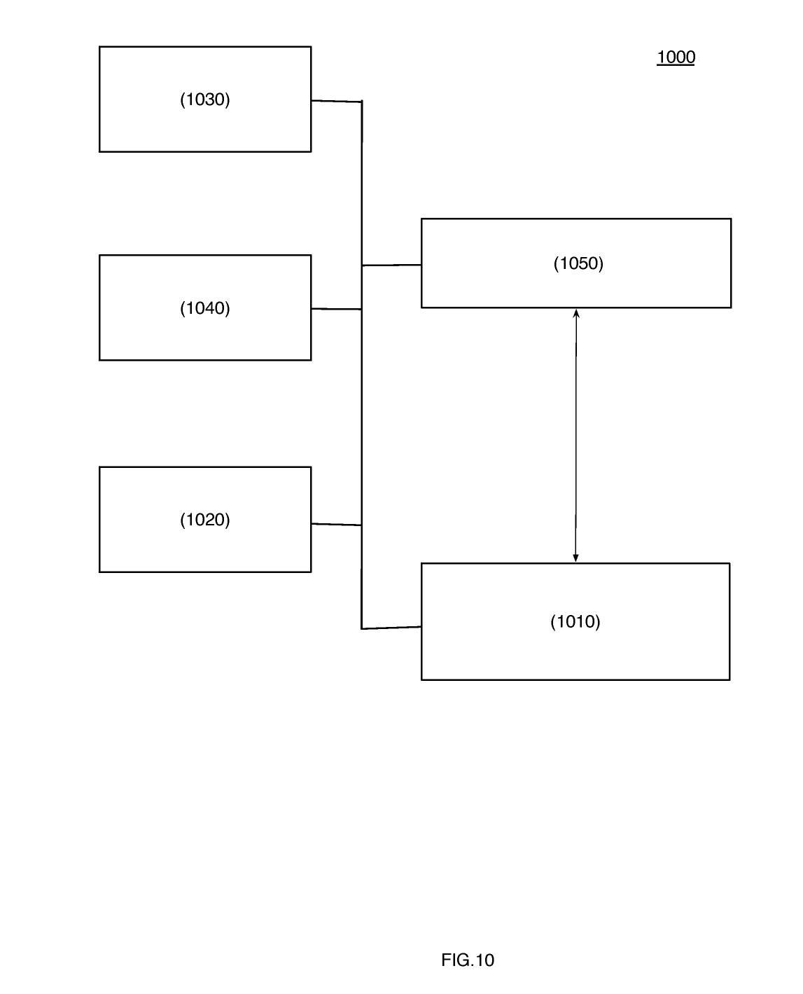

Another aspect of the invention is a transformation apparatus 1000 of FIG. 10 for grading compliance of documents to category best practices having a knowledge base 1010 of best practices approved or desired for agreements; coupled to, a parsing engine 1020 to determine key elements (key words, sections, subtitles, paragraphs; a document categorization filter to direct a submitted document to a scoring engine; a clause identifier circuit 1030 to determine sections which require certain evaluations; a scoring engine 1040 to quantify how close each section is to a desired or preferred goal; and an information engine 1050 to integrate, receive, store, and display results of analysis and commentary.

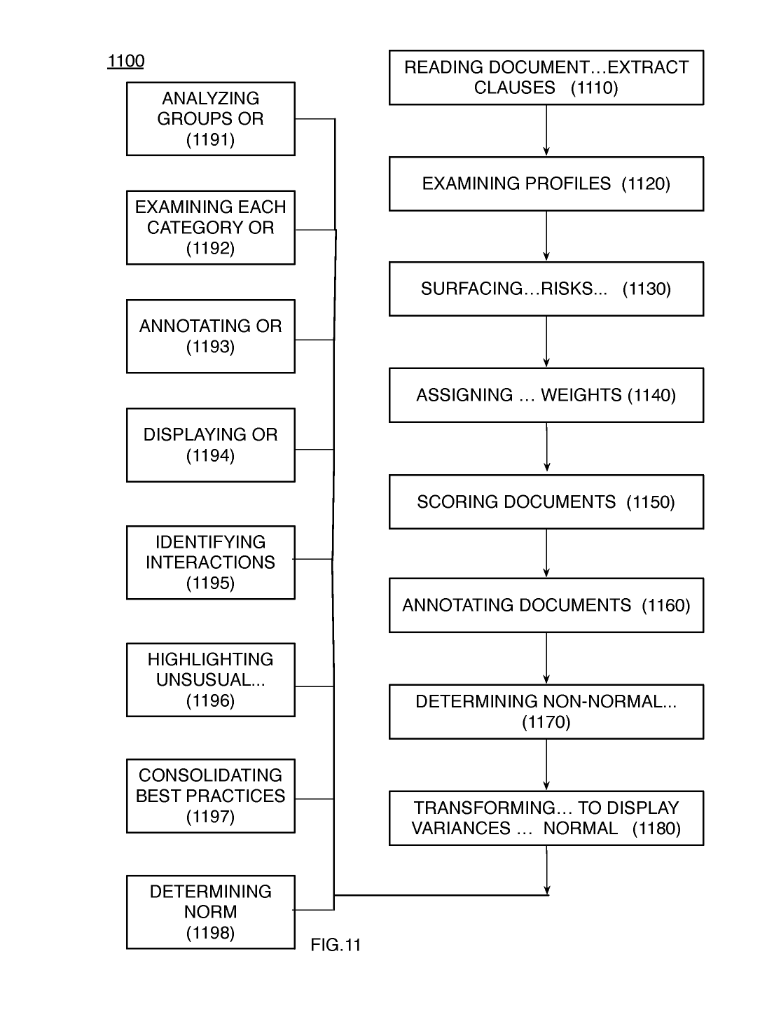

Another aspect of the invention is a method 1100 of FIG. 11 for operating a processor to cause transformation of legal agreements into clause clusters for scoring, by reading 1110 a plurality of documents to extract clauses; examining 1120 profiles of clauses for characteristics of a category; surfacing clauses 1130 which incur risks or liability; assigning 1140 positive or negative weights to clauses by rules; scoring documents 1150 according to components; annotating documents 1160 by missing parts and scores; determining non-normal components 1170; and transforming 1180 a document to display risks and variances from normal.

In an embodiment the method further includes analyzing 1191 groups of clauses to surface potential risk and liability across all contracts agreed to by an enterprise; or examining 1192 each category of document using rules that provide positive or negative scores; or annotating 1193 and displaying 1194 normally present clauses and absences and variations for each category of document; or identifying 1195 interaction between and among contractual obligations negotiated separately which in combination constrain the freedom of an enterprise to operate or generate liability and compliance exposures; or highlighting 1196 unusual or non-standard limitations, and consolidating 1197 best practices among acquired operating business; and determining 1198 a golden, legacy norm, industry standard, or consensus acceptable form to screen incoming or proposed outgoing documents for scoring and scoping within a workflow.

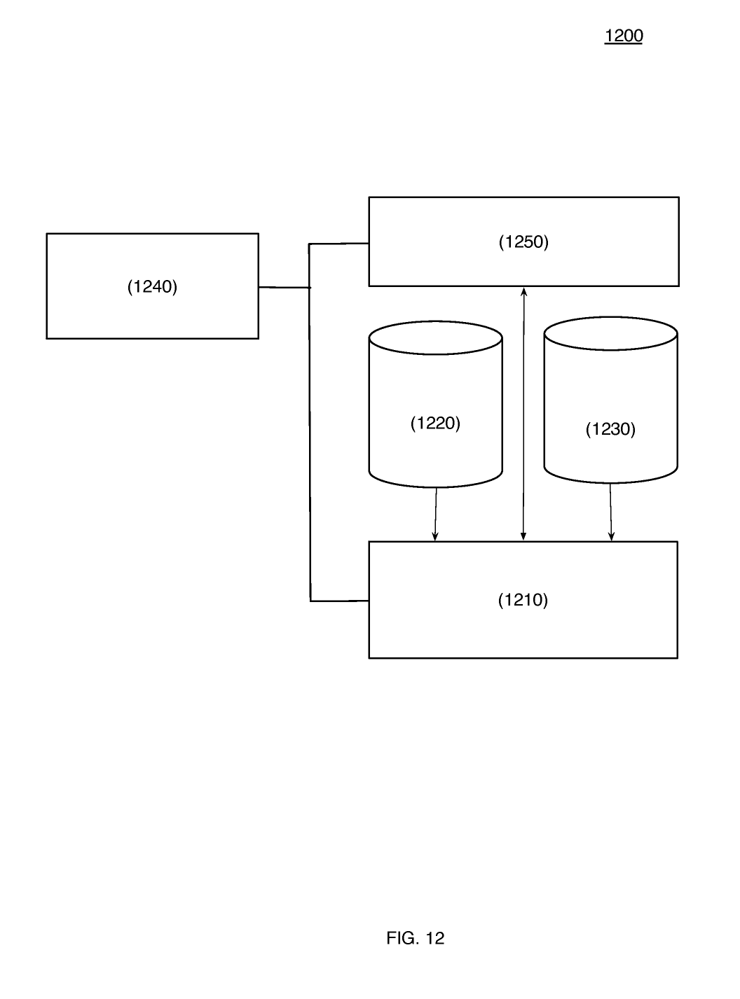

Another aspect of the invention is a system 1200 of FIG. 12 to control document security and ensure corporate governance including a server 1210 configured to receive legal instruments in electronic form and categorize the legal instruments by component clauses; a data store 1220 containing profiles by which clause groups are screened for risk and liability; a rule base 1230 for each category against which legal instruments may be scored; a transformation circuit 1240 which causes a display to visually indicate clauses which are non-normative for their category and insert commentary to highlight missing clauses; and a user console 1250 by which principals can designate clause pairs legally equivalent.

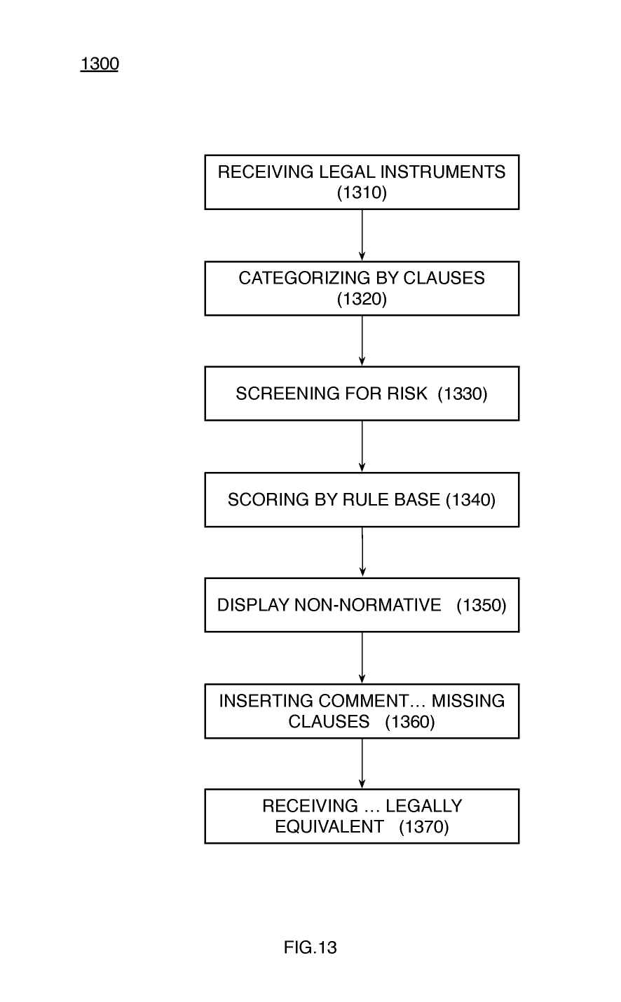

Another aspect of the invention is a method 1300 of FIG. 13 to control document security and ensure corporate governance by receiving 1310 legal instruments in electronic form and categorizing 1320 the legal instruments by component clauses; screening 1330 clause groups for risk and liability; scoring 1340 legal instruments by a rule base for each category; causing 1350 a display to visually indicate clauses which are non-normative for their category and inserting 1360 commentary to highlight missing clauses; and receiving 1370 from principals that clause pairs are legally equivalent.

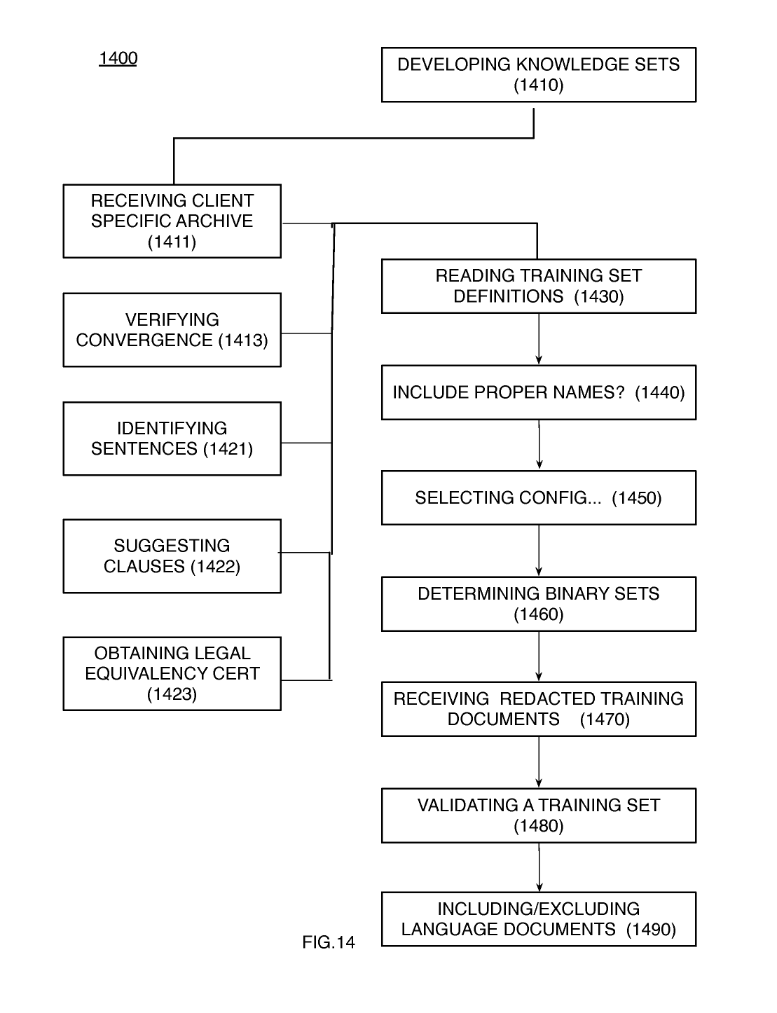

Another aspect of the invention is a document categorization training process 1400 of FIG. 14 for developing a licensable golden, industry standard, approved form, or legacy norm for a category of documents which generates a computer-readable best practices (BP) knowledge base which may be used for scoring and scoping an archive or an incoming document by for each target workflow/market micro-segment, developing 1410 multi-category document knowledge sets by receiving 1411 company/client specific confidential archive of sentences licensed for sole use of provider; verifying 1413 training set convergence to goal by identifying 1421 sentences, suggesting 1422 clauses for sentences, and obtaining 1423 legal equivalency certification from client corporate attorneys/partners; reading 1430 stored training set definitions, comprising all combinations of all printable characters or alpha only, all words or first M characters where M is set default to 1 k, choosing 1440 to include or exclude Proper names, capitalized acronyms, non-dictionary strings, etc.; selecting configuration 1450 from one of unigrams, bigrams, trigrams, binary strings of sentences; determining 1460 binary sets by category, receiving 1470 confidential/redacted training documents for use only per categorized documents for both in/out groupings; validating 1480 a training set document creation profile, the profile including one or more of: using one of all printable characters or alpha only, using a fixed number of words or characters, using or not using proper names, and including or excluding certain language documents 1490.

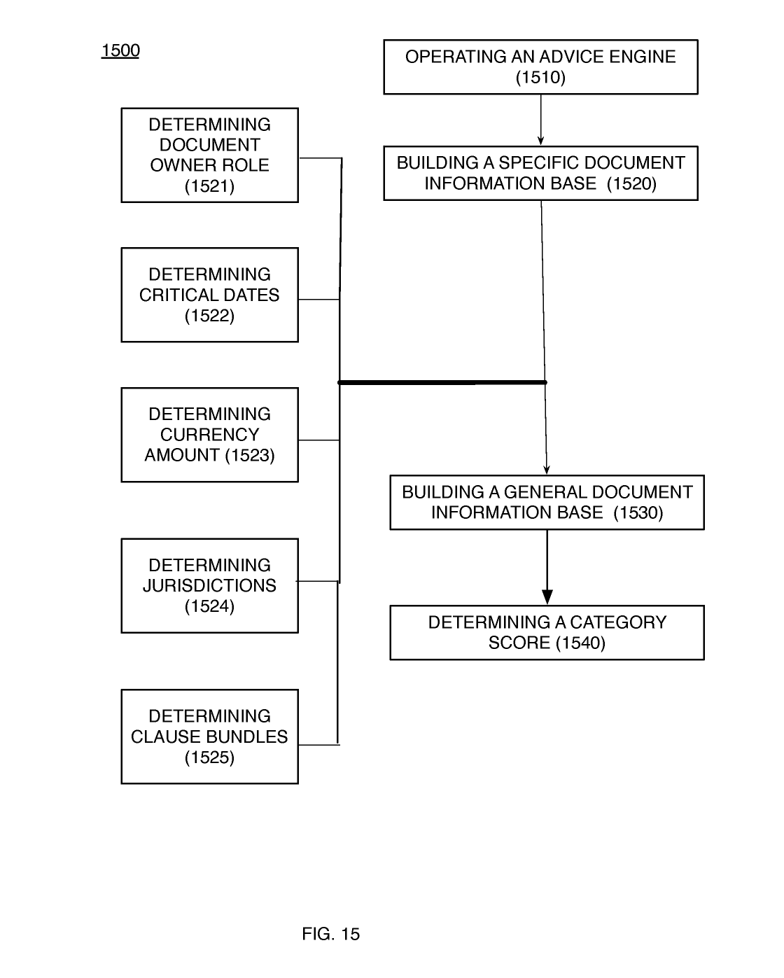

Another aspect of the invention is a method 1500 of FIG. 15 for generating document advice on a document by operating 1510 a document advice engine by building 1520 a specific document information base and building a general document knowledge base 1530. In an embodiment, building a specific document information base means determining 1521 a document owner role; determining 1522 critical dates not limited to exemplary dates: effective date, end date, renewal date; determining 1523 currency amount not limited to exemplary amounts: total amount and annual amount, penalty amounts; determining jurisdictions 1524 not limited to exemplary states, countries, EU, treaties, global; determining clause bundles 1525 from clause bundle keyword scan for positive clauses and negative clauses; determining 1526 clauses to be positive clauses or negative clauses; and 1540 determining a category score.

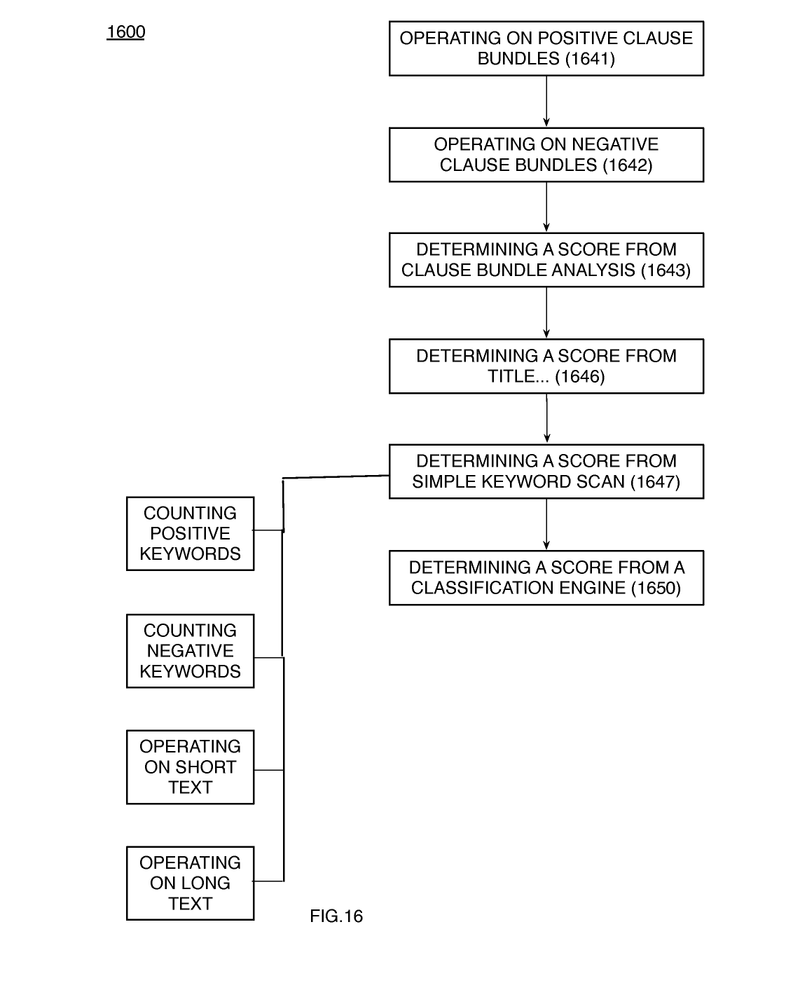

In an embodiment, determining a category score 1600 of FIG. 16 means operating 1641 on positive clause bundles and operating 1642 on negative clause bundles; determining 1643 a score from clause bundle analysis, determining a score 1646 from a title of the document, by aggregating negative keywords by category and positive keywords by category; determining a score 1647 from simple keyword scan, wherein the simple keyword scan comprises counting positive keywords by category, counting negative keywords by category, operating on short text (e.g. first 100 words) and operating on full text; and determining a score from a classification engine 1650.

In an embodiment, the classification engine is at least one of maximum entropy, naive Bayes, a matching algorithm training set of documents, among other classification engines.

In an embodiment, the method also includes determining a score from clause analysis, wherein clause analysis comprises determining a score from positive clauses and from negative clauses.

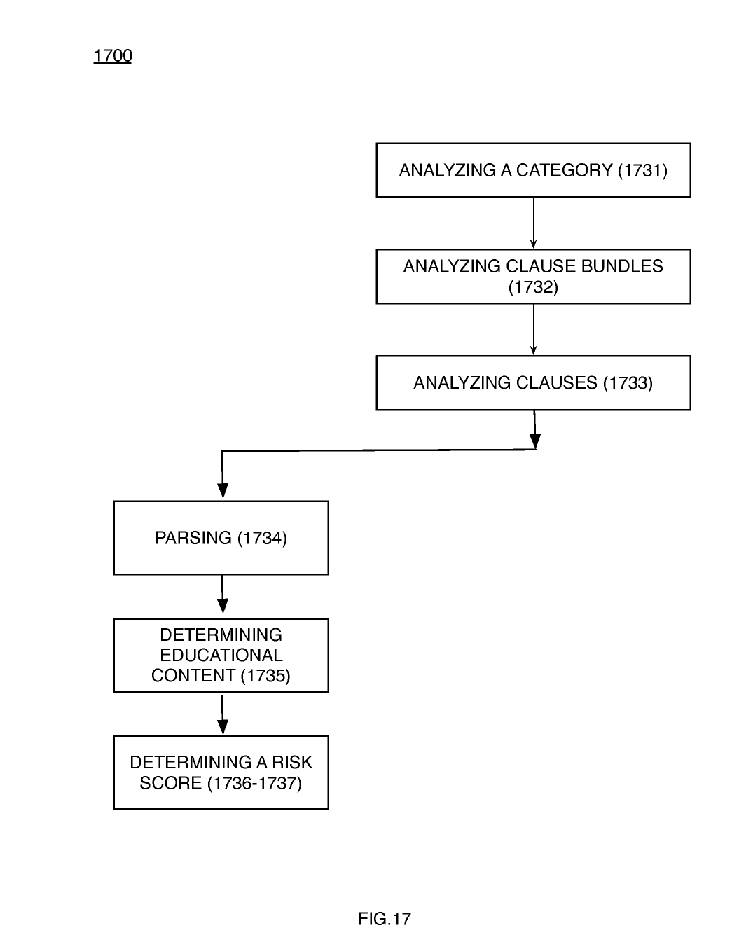

In an embodiment, building a general document knowledge base 1700 of FIG. 17 is accomplished by analyzing 1731 a category; analyzing 1732 clause bundles; and analyzing clauses 1733. Analyzing clauses is accomplished by parsing 1734 what keywords are useful per clause, determining educational content 1735 by clause by category, determining a risk score 1736 by clause by category, and determining a risk score 1737 by clause by clause bundle; wherein analyzing clause bundles includes determining what clauses are useful per clause bundle, determining educational content by clause bundle by category, and determining a risk score by clause bundle by category; wherein analyzing a category is done by determining what clause bundles are useful per category, determining educational content by category, determining what clauses are useful by category, and determining what clauses are negative by category.

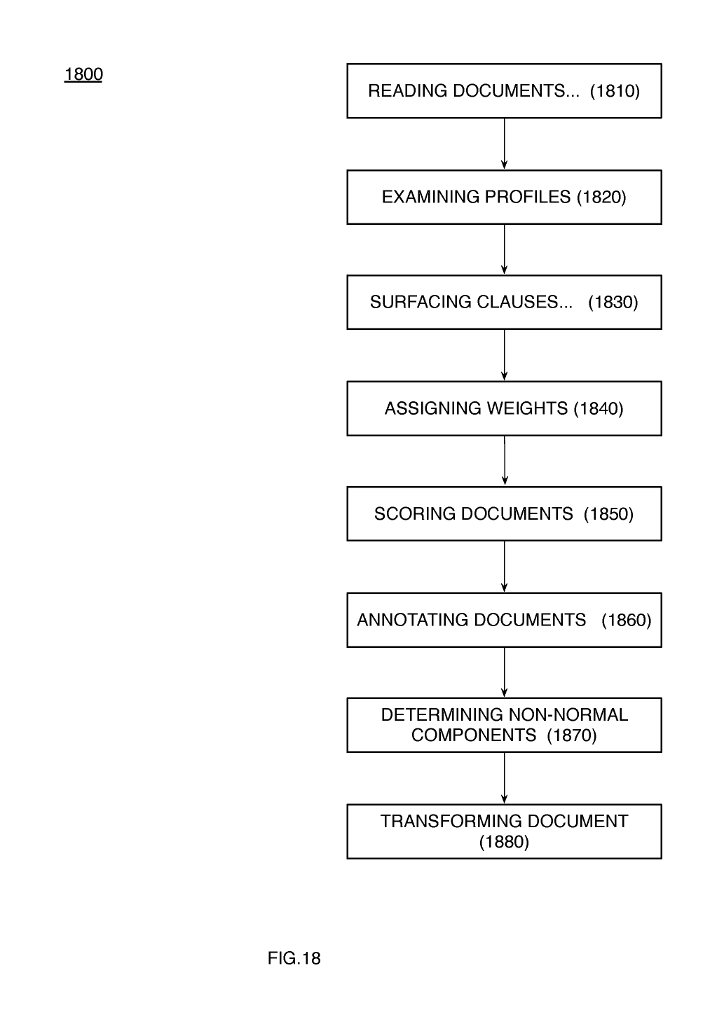

One aspect of the invention is a computer implemented method 1800 of FIG. 18 for transformation of legal agreements into clause clusters for scoring by reading 1810 a plurality of documents to extract clauses; examining 1820 profiles of clauses for characteristics of a category; surfacing clauses 1830 which incur risks or liability; assigning positive or negative weights to clauses by rules 1840; scoring documents 1850 according to components; annotating documents 1860 by missing parts and scores; determining non-normal components 1870; and transforming a document 1880 to display risks and variances from normal.

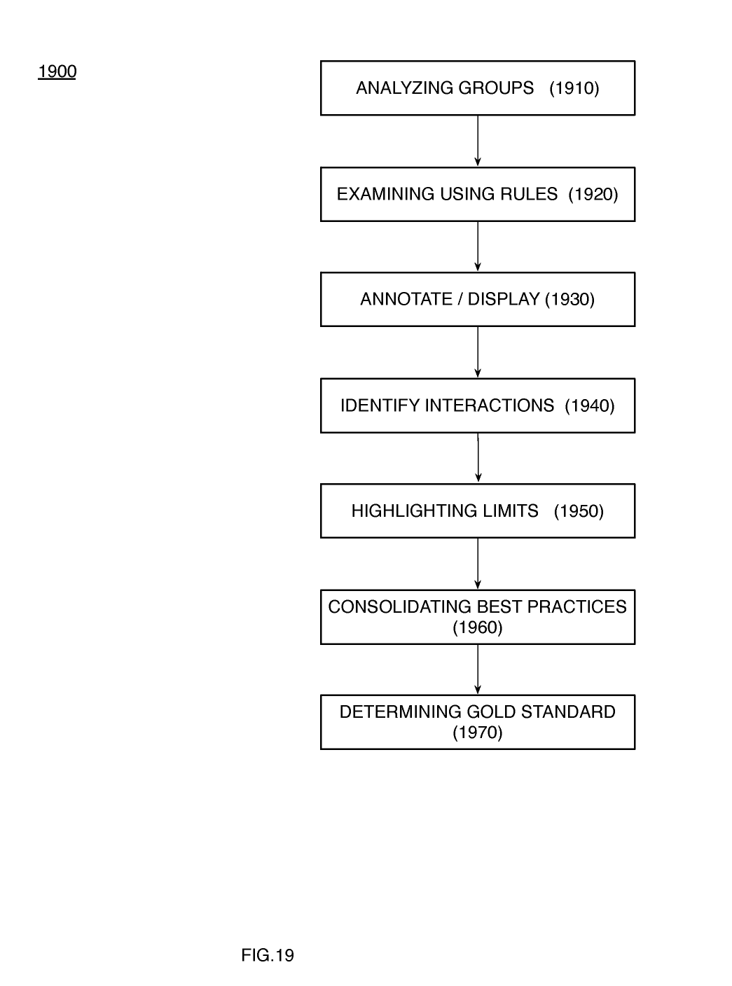

In an embodiment the method 1900 of FIG. 19 also includes analyzing groups 1910 of clauses to surface potential risk and liability across all contracts agreed to by an enterprise; examining 1920 each category of document using rules that provide positive or negative scores; annotating and displaying 1930 normally present clauses and absences and variations for each category of document; identifying interaction 1940 between and among contractual obligations negotiated separately which in combination constrain the freedom of an enterprise to operate or generate liability and compliance exposures; highlighting 1950 unusual or non-standard limitations, and consolidating 1960 best practices among acquired operating business; and determining 1970 a golden, legacy norm, industry standard, or consensus acceptable form to screen incoming or proposed outgoing documents for scoring and scoping within a workflow.

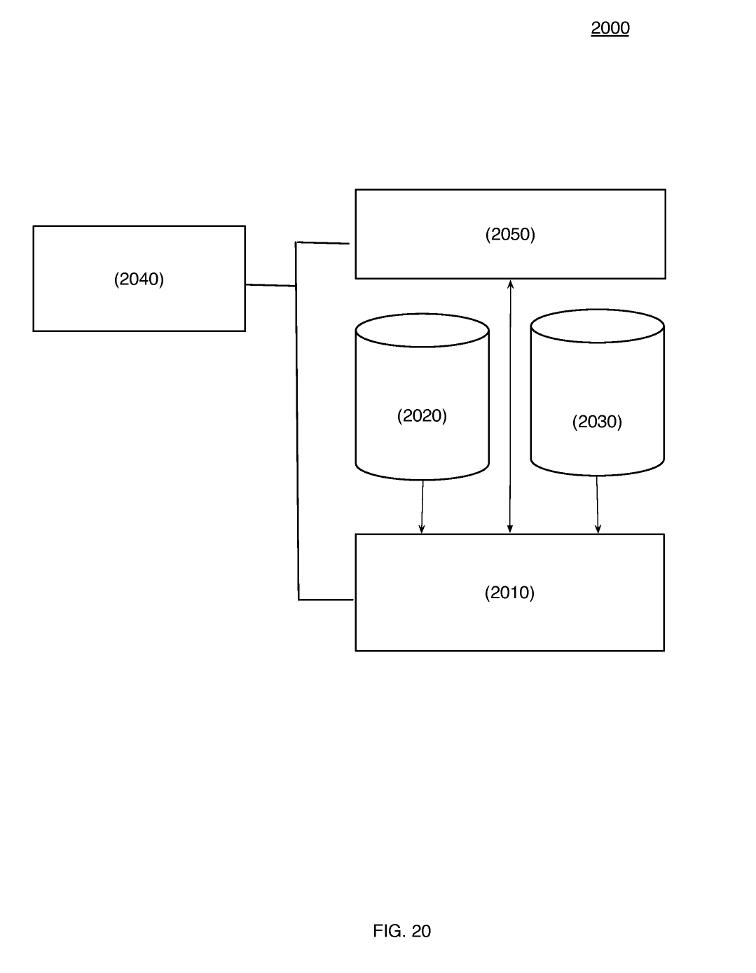

One aspect of the invention is system 2000 of FIG. 20 to control document security and ensure corporate governance having a server 2010 configured to receive legal instruments in electronic form and categorize the legal instruments by component clauses; a data store 2020 containing profiles by which clause groups are screened for risk and liability; a rule base 2030 for each category against which legal instruments may be scored; a transformation circuit 2040 which causes a display to visually indicate clauses which are non-normative for their category and insert commentary to highlight missing clauses; and a user console 2050 by which principals can designate clause pairs legally equivalent.

### CONCLUSION

The present invention is easily distinguished from conventional workflow management, content control, and document categorization by scoring compliance with best practices and legacy policies for each industry or enterprise. Each category of legal agreements and documents are scored according to clusters of clauses. For each category rules are applied to measure consistency with best practices, industry standards, and a company's legacy policies. Work items are flagged if they are out-of-norm, create liability or compliance exposure, or contain mutually conflicting commitments. Rules are applied to ensure that corporate governance exceptions are remediated, workflow escalations are appropriate to the authority of the actors, and security is maintained over control of document access. Documents are transformed with annotations on the clauses or sections which are out of norm or violate legacy policies.

Beneficially, the present invention provides for reviewing and analyzing certain document categories which are in the critical path for agreements or in anticipation of liability and compliance exposures for the C-level staff and board of directors.

The present invention solves the costly problem of reviewing and analyzing certain document categories in anticipation of liability and compliance exposures which is requisite for organizations but consumes a time and expense for their executives, their staff, their attorneys, their owners, or their representatives and may substantially delay revenue recognition.

The techniques described herein can be implemented in digital electronic circuitry, or in computer hardware, firmware, software, or in combinations of them. The techniques can be implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps of the techniques described herein can be performed by one or more programmable processors executing a computer program to perform functions of the invention by operating on input data and generating output. Method steps can also be performed by, and apparatus of the invention can be implemented as, special purpose logic circuitry, e.g., an FPGA (field programmable gate array) or an ASIC (application-specific integrated circuit). Modules can refer to portions of the computer program and/or the processor/special circuitry that implements that functionality.

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in special purpose logic circuitry.

### An Exemplary Computer System

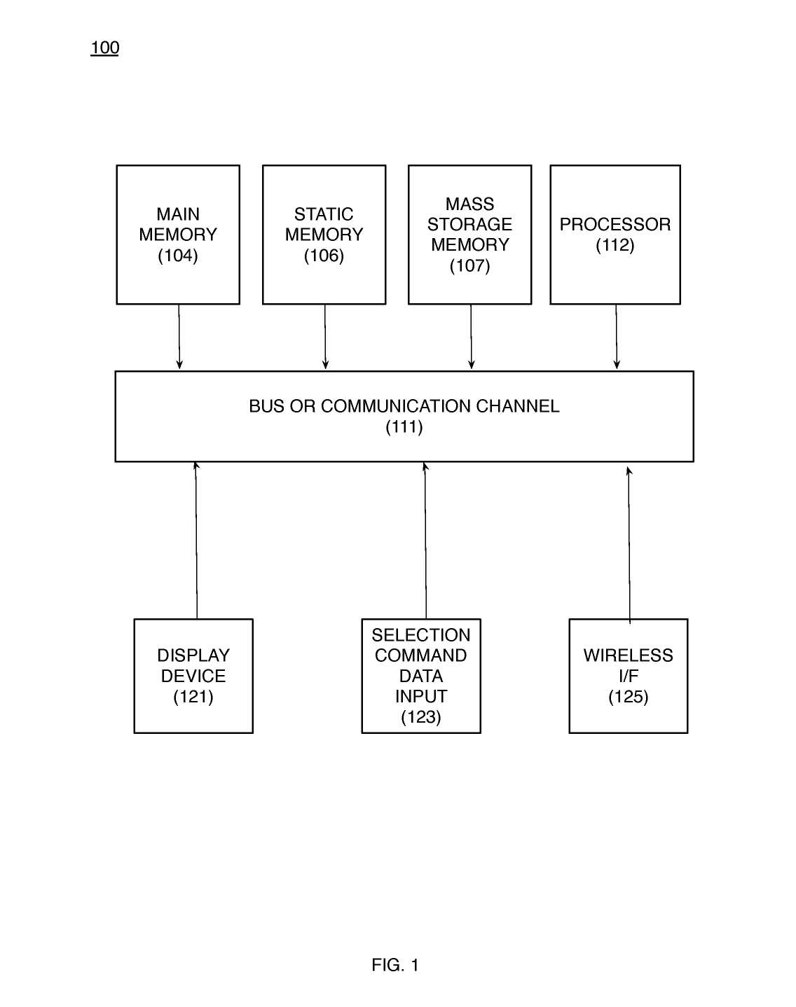

FIG. 1 is a block diagram of an exemplary computer system that may be used to perform one or more of the functions described herein. Referring to FIG. 1, computer system 100 may comprise an exemplary client or server 100 computer system. Computer system 100 comprises a communication mechanism or bus 111 for communicating information, and a processor 112 coupled with bus 111 for processing information. Processor 112 includes a microprocessor, but is not limited to a microprocessor, such as for example, ARM™, Pentium™, etc.

System 100 further comprises a random access memory (RAM), or other dynamic storage device 104 (referred to as main memory) coupled to bus 111 for storing information and instructions to be executed by processor 112. Main memory 104 also may be used for storing temporary variables or other intermediate information during execution of instructions by processor 112.

Computer system 100 also comprises a read only memory (ROM) and/or other static storage device 106 coupled to bus 111 for storing static information and instructions for processor 112, and a non-transitory data storage device 107, such as a magnetic storage device or flash memory and its corresponding control circuits. Data storage device 107 is coupled to bus 111 for storing information and instructions.

Computer system 100 may further be coupled to a display device 121 such a flat panel display, coupled to bus 111 for displaying information to a computer user. Voice recognition, optical sensor, motion sensor, microphone, keyboard, touch screen input, and pointing devices 123 may be attached to bus 111 or a wireless interface 125 for communicating selections and command and data input to processor 112.

Note that any or all of the components of system 100 and associated hardware may be used in the present invention. However, it can be appreciated that other configurations of the computer system may include some or all of the devices in one apparatus, a network, or a distributed cloud of processors.

A number of embodiments of the invention have been described. Nevertheless, it will be understood that various modifications may be made without departing from the spirit and scope of the invention. For example, other network topologies may be used. Accordingly, other embodiments are within the scope of the following claims.

What is claimed is:

1. A network device having a processor coupled to a document store, a directory of users and resources, and a network interface;
a circuit to determine groups of clauses embedded in a selected document;
a circuit to identify an authority of a user to access a distribution medium related to a category of clause groups;
a circuit to enable or deny a request from an authorized user to access a distribution medium for a document having a group of clauses; and
a circuit to record the success or failure of an authorized user to access a distribution medium for a document having a category of clause groups; wherein a clause is a group of words which are syntactically related containing a subject and predicate and forming part of a sentence or constituting a whole simple sentence.

2. The network device of claim 1 wherein a distribution medium is a removable personal store.

3. The network device of claim 1 wherein a distribution medium is email.

4. The network device of claim 1 wherein a distribution medium is a website.

5. The network device of claim 1 wherein a distribution medium is an upload to an IP server.

6. The network device of claim 1 wherein a distribution medium is a data communication logical device.
